(19) United States
(12) Patent Application Publication
(10) Pub. No.: US 2014/0124673 A1
(43) Pub. Date: May 8, 2014

(54) MEASURING SYSTEM FOR MEASURING THE CO2 CONCENTRATION IN A CLIMATE CABINET OR AN INCUBATOR

(71) Applicant: Binder GmbH, Tuttlingen (DE)

(72) Inventors: Dieter Baschant, Geisingen/Pfohren (DE); Peter Michael Binder, Orsingen-Nenzingen (DE); Holger Von Both, Engen (DE); Andre Magi, Mertendorf (DE); Patrick Sachse, Kraftsdorf (DE); Steffen Biermann, Hermsdorf (DE)

(73) Assignee: Binder GmbH, Tuttlingen (DE)

(21) Appl. No.: 14/155,464

(22) Filed: Jan. 15, 2014

Related U.S. Application Data
(63) Continuation of application No. 13/996,013.

(30) Foreign Application Priority Data
Dec. 20, 2010 (DE) 102010055182.1-52

(51) Int. Cl. G01N 21/61

(52) U.S. Cl. CPC G01N 21/61
USPC 250/343

(57) ABSTRACT

A measurement system for measuring the CO₂ concentration in an environmental chamber or in an incubator has a radiation source with an optical axis and at least two radiation detectors. The radiation source and the radiation detectors are arranged such with respect to one another that the radiation emitted by the radiation source impinges, after passing through a measurement volume, on the radiation detectors. In each case one channel having a first end and a second end is provided for each radiation detector. The radiation detector is arranged at the first end and the first end of the channel is remote from the radiation source. The channels have a diameter which is smaller than the diameter of the measurement volume, transverse to the optical axis.

### RELATED APPLICATIONS

This application is a continuation of U.S. patent application Ser. No. 13/996,013, which is the 371 US nationalization of PCT/EP2011/006376, filed Dec. 16, 2011, which are both incorporated herein by reference.

### TECHNICAL FIELD

This application relates to a measurement system for measuring the CO₂ concentration in an environmental chamber or in an incubator.

### BACKGROUND OF THE INVENTION

Measurement systems for measuring the CO₂ concentration are known, which comprise a radiation source and at least two radiation detectors, wherein the radiation source and the radiation detectors are arranged in such a way in relation to one another that the radiation emitted by the radiation source impinges on the radiation detectors after traversing a measurement volume.

It is desirable to provide a measurement system for measuring the CO₂ concentration which can also be used in environmental chambers or incubators and is therefore not damaged either at temperatures at which sterilization occurs, i.e., in particular, at temperatures of 180°. Many known measurement systems for measuring the CO₂ concentration are not temperature stable.

It is therefore desirable to provide a measurement system for measuring the CO₂ concentration, which can be used in environmental chambers or incubators.

### SUMMARY OF THE INVENTION

A measurement system according to the system described herein for measuring the CO₂ concentration in an environmental chamber or in an incubator comprises a radiation source with an optical axis and at least two, preferably three, radiation detectors, wherein the radiation source and the radiation detectors are arranged in such a way in relation to one another that the radiation emitted by the radiation source impinges on the radiation detectors after traversing a measurement volume, and is distinguished by virtue of the fact that respectively one channel with a first end and a second end is provided for each radiation detector, wherein the radiation detector is arranged at the first end and the first end of the channel is distant from the radiation source and wherein the channels have a diameter which is smaller than the diameter of the measurement volume across the optical axis.

Hence, the light, which impinges on the radiation detectors in this arrangement, must initially transverse the channel belonging to the radiation detector. As a result of the channels having a diameter which is smaller than the diameter of the measurement volume, the end of the channel facing the radiation source acts like a stop and therefore reduces the entrance of stray light into the corresponding channel. Moreover, what is brought about by the longitudinal extent of the channel is that stray light which entered the channel through the first end generally cannot impinge on the radiation detector arranged at the end of the channel. Overall, the arrangement according to the invention practically precludes incidence of reflected radiation on the radiation detectors. Hence, the measurement system is particularly suitable for use in environmental chambers or in incubators, where it is exposed to large temperature variations.

According to an embodiment of the system described herein, the channels have an axis, wherein the axis of at least one of the channels, preferably of all of the channels, is arranged inclined at an angle with respect to the optical axis. This can achieve a direct beam path between the radiation source and the radiation detector for a plurality of radiation detectors.

The ratio of distance between the radiation source and one of the radiation detectors to the length of the channel belonging to the radiation detector is advantageously approximately 4:1. This design can reliably reduce the incidence of reflected radiation on the radiation detector.

According to an embodiment of the system described herein, the radiation detectors have a radiation-sensitive surface, which is arranged tangentially in relation to a spherical surface. As a result of this arrangement, it is possible to enable a substantially perpendicular incidence of the radiation emitted by the radiation source on all radiation detectors.

The radiation source is preferably embodied as an infrared radiation source, in particular as a thermal radiation source, which is particularly suitable for the application in measurement systems for measuring the CO₂ concentration.

The radiation source and the radiation detectors are preferably arranged in a housing, which encloses the measurement volume and which comprises a base part, a cover part and a central part arranged between the base part and the cover part, wherein, preferably, the radiation source is arranged in the base part and/or the radiation detectors are arranged in the cover part. This enables a simple and cost-effective design of the measurement system.

The central part is preferably made of plastic, which enables a cost-effective production and thermal decoupling between the emitter element and infrared detector.

The inner side of the central part particularly preferably has a structured surface, ribs or a thread, in particular a fine thread in order thereby to suppress reflections on the inner side of the central part as far as possible.

The channels are preferably arranged in the cover part, which enables a simple and cost-effective production.

According to an embodiment of the system described herein, the cover part is made of aluminum, the surface of which is preferably anodized. The production from aluminum renders it possible to keep the radiation detectors at a desired temperature and to dissipate the accumulating heat. Using anodized aluminum largely avoids reflections on the cover part, in particular on the channel inner walls.

### BRIEF DESCRIPTION OF THE DRAWINGS

Embodiments of the system described herein will be explained in detail on the basis of the following figures, which are briefly described as follows:

FIG. 1 shows a perspective view of a measurement system according to the system described herein,

FIG. 2 shows a side view of the measurement system in accordance with FIG. 1,

FIG. 3 shows a longitudinal section through the measurement system in accordance with FIG. 1,

FIG. 4 shows a top view of the measurement system in accordance with FIG. 1,

FIG. 5 shows a magnification of a section from FIG. 3,

FIG. 6 shows a perspective plan view of a cover part of the measurement system in accordance with FIG. 1,

FIG. 7 shows a side view of the cover part in accordance with FIG. 6,

FIG. 8 shows a top view of the cover part in accordance with FIG. 6,

FIG. 9 shows a perspective view of a further exemplary embodiment of a cover part,

FIG. 10 shows a further perspective view of the cover part in accordance with FIG. 9 and

FIG. 11 shows a top view of the cover part in accordance with FIG. 9.

The same reference signs denote equivalent or functionally equivalent parts, wherein, for improved clarity, not all reference signs are provided in all figures.

### DETAILED DESCRIPTION OF VARIOUS EMBODIMENTS

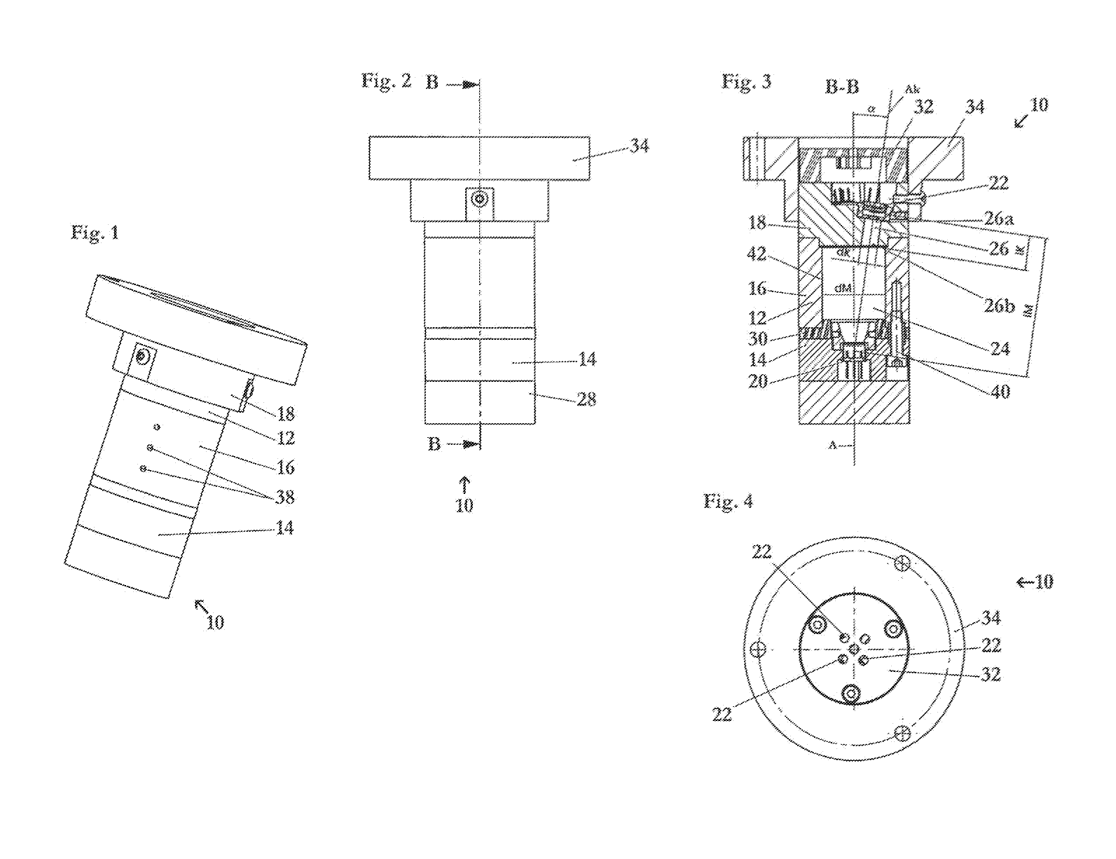

FIGS. 1 to 5 show different views of a measurement system 10 for measuring the CO₂ concentration in an environmental chamber or an incubator. The measurement system 10 comprises a housing 12, which comprises a base part 14, a central part 16 and a cover part 18. The central part 16 is arranged between the base part 14 and the cover part 18 and preferably has a tubular design. The housing 12 surrounds the measurement volume 24, wherein one or more gas passage openings 38 are arranged in the central part 16 and/or the cover part 18, by means of which gas passage openings the gas to be examined can enter the measurement volume 24 of the measurement system 10.

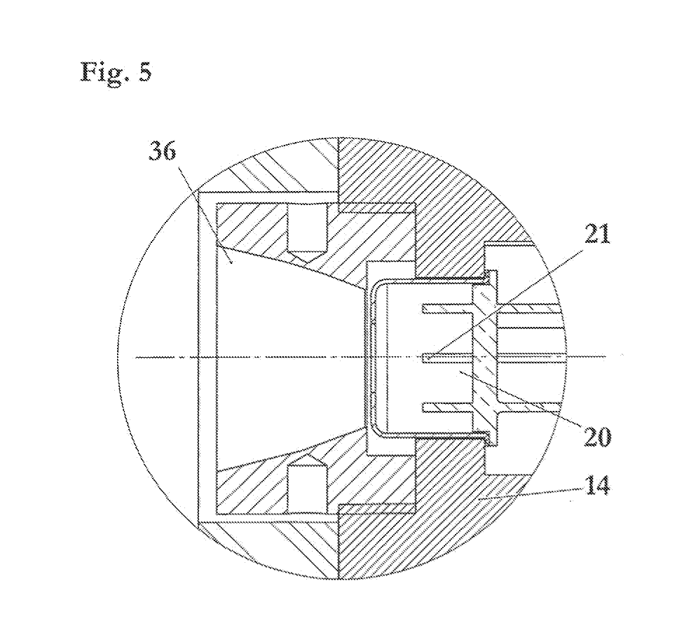

The measurement system 10 comprises a radiation source 20 and three radiation detectors 22. The radiation source 20 (cf., in particular, FIG. 5) is arranged in the base part 14 and, for example, embodied as infrared radiation source, in particular as thermal radiation source. The radiation source 20 therefore in particular has an emitter surface 21, in front of which a reflector element 36 is arranged for focusing the emitted radiation. The radiation source 20 in particular has an optical axis A.

The base part 14 is screwed to the central part 16 with the aid of screws 40, wherein an insulation element 30, which serves for heat insulation, is preferably arranged between the base part 14 and the central part 16. A cooling body 28, which for example has cooling fins and serves for cooling the base part 14, is preferably arranged on the base part 14.

A channel 26 is assigned to each of the radiation detectors 22, wherein each of the channels 26 has a first end 26a and a second end 26b. Here, the radiation detector 22 is arranged at the first end 26a of the channel 26, wherein the channel 26 is aligned in such a way that the first end 26a of the channel 26 is distant from the radiation source 20, while the second end 26b of the channel 26 is close to the radiation source 20. Each of the channels 26 has an axis AK. The channels 26 are, in particular, arranged in the cover part 18 and are embodied, in particular, as passage openings through the cover part 18.

The radiation detectors 22 have a radiation-sensitive surface, which are arranged substantially tangentially on a spherical surface around the radiation source 20. This renders it possible for light emitted by the radiation source 20 to impinge substantially perpendicular onto all radiation detectors 22. Moreover, the radiation detectors 22 are preferably arranged at the corners of an equilateral triangle in order to enable uniform radiation incidence on all radiation detectors 22. So that the direct beam path between the radiation source 20 and the respective radiation detector 22 is not adversely affected by the channels 26, the axis AK of the channels 26 is arranged inclined at an angle α with respect to the optical axis A. The angle α in this case is approximately 10°.

However, the channels 26 prevent the incidence of stray light on the radiation detectors 22. The channels 26 have a diameter dK, which is less than a diameter dM of the central part 16 and, in particular, less than the diameter dM of the central part of the measurement volume 24 across the optical axis A. This is how the second end 26b of the channel 26 achieves a stop effect, as a result of which the incidence of stray light is reduced. The incidence of stray light is furthermore reduced by the longitudinal extent of the channels 26. A ratio of the length lK of the channel 26 to the distance lM between the radiation source 20 and one of the radiation detectors 22 of 1:4 (cf., in particular, FIG. 3) is particularly expedient for avoiding the incidence of stray light.

In order to reduce radiation reflections in the interior of the housing 12 further, the central part 16 preferably has a structured surface, for example in the form of a fine thread 42, on the inner surface. The central part 16 is made of plastic in particular, since plastic is a low reflection material, which ensures the thermal decoupling between emitter and detector and can be processed in a cost-effective manner. The cover part 18 is preferably made of aluminum in order to be able to dissipate the heat accumulating in the radiation detectors 22 better. In order to avoid reflections, particularly on the inner sides of the channels 26, the cover part 18 is preferably made of anodized aluminum.

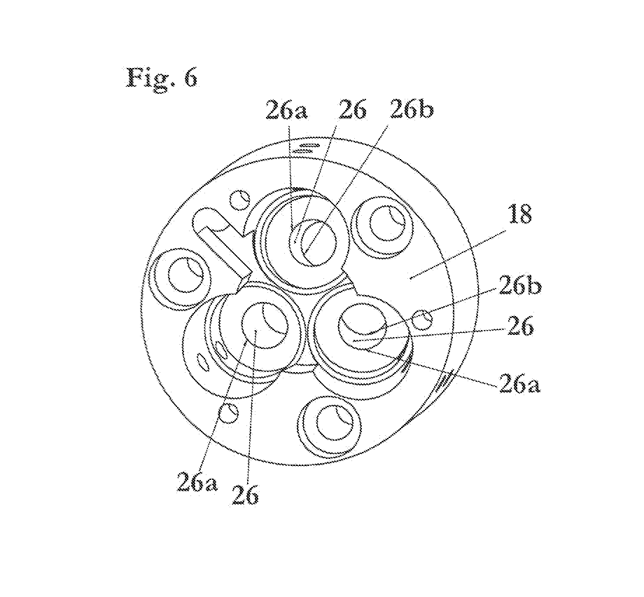

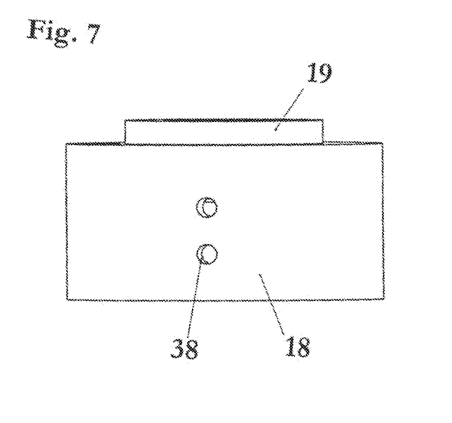

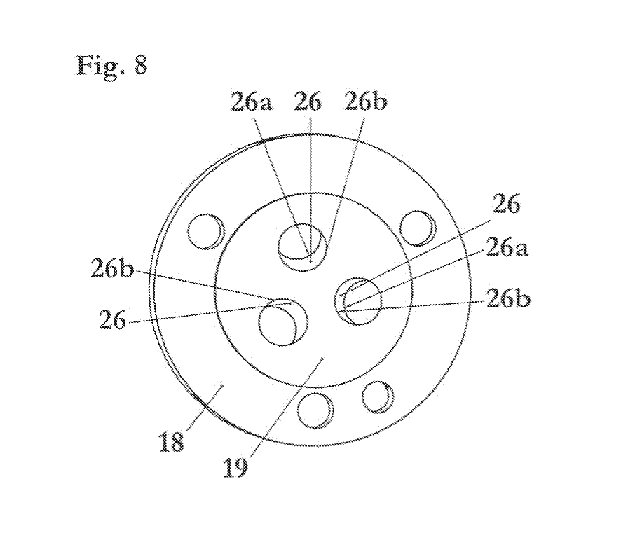

FIGS. 6 to 8 show further views of the cover part 18. The cover part 18 has a substantially cylindrical design and has a cylindrical projection 19 with a relatively small diameter on the end face close to the central part 16, which projection can be inserted into the central part 16 in an interlocking manner. The cover part 18 can be screwed onto the central part 16 by means of screws (not illustrated). The end face of the cover part 18 distant from the measurement volume 24 can be covered by an insulation element 32. Moreover, an assembly flange 34 for assembling the measurement system 10 in an environmental chamber or in an incubator can be arranged on the side of the cover part 18 distant from the measurement volume 24.

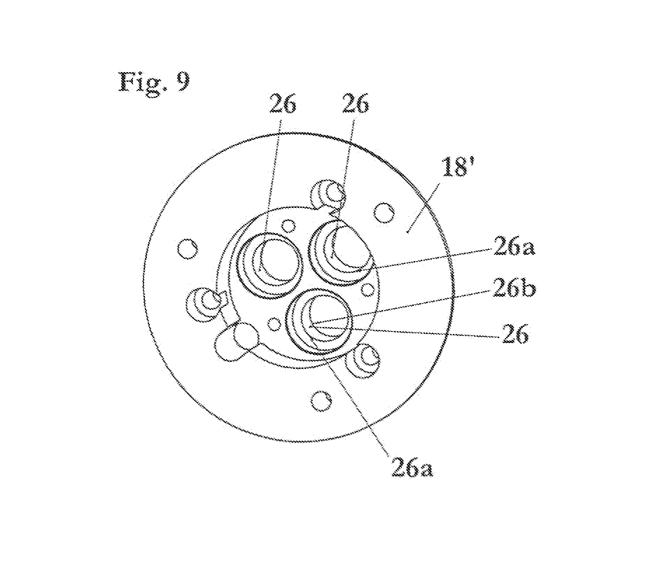

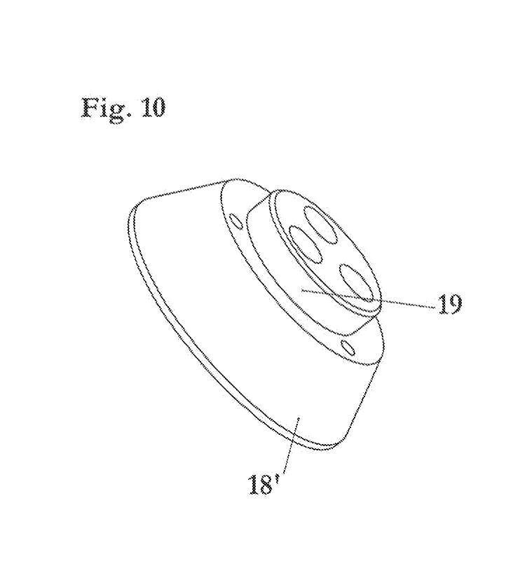

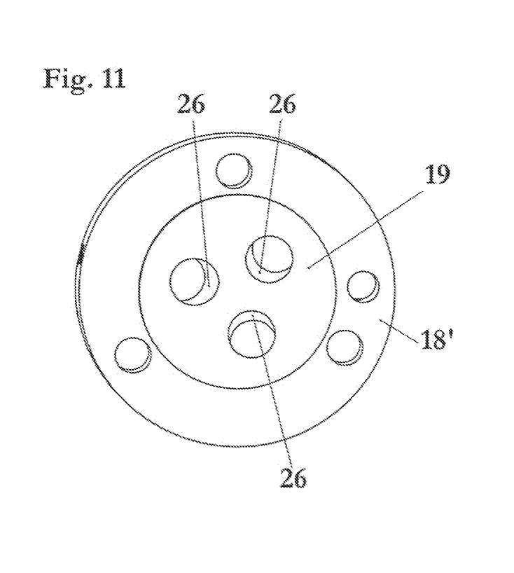

FIGS. 9 to 11 show different views of an alternative exemplary embodiment of a cover part 18′, which merely differs from the cover part 18 in accordance with FIGS. 6 to 8 by virtue of the fact that the cover part 18′ is not cylindrical, but rather has a design with a conical taper.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A measurement system for measuring the CO₂ concentration in an environmental chamber or in an incubator, comprising:
a radiation source with an optical axis and at least two radiation detectors, wherein the radiation source and the radiation detectors are arranged in such a way in relation to one another that radiation emitted by the radiation source impinges on the radiation detectors after traversing a measurement volume, wherein respectively one channel with a first end and a second end is provided for each radiation detector, wherein the radiation detector is arranged at the first end, wherein the first end of the channel is distant from the radiation source, and wherein the channels have a diameter which is smaller than the diameter of the measurement volume across the optical axis.

2. The measurement system as claimed in claim 1, wherein the channels have an axis, and wherein the axis of at least one of the channels is arranged inclined at an angle with respect to the optical axis.

3. The measurement system as claimed in claim 1, wherein a ratio of a distance between the radiation source and one of the radiation detectors to a length of the channel belonging to the radiation detector is approximately 4:1.

4. The measurement system as claimed in claim 1, wherein the radiation detectors have a radiation-sensitive surface, which is arranged tangentially in relation to a spherical surface.

5. The measurement system as claimed in claim 1, wherein the radiation source is embodied as an infrared radiation source.

6. The measurement system as claimed in claim 1, wherein the radiation source and the radiation detectors are arranged in a housing, which encloses the measurement volume and which comprises a base part, a cover part and a central part arranged between the base part and the cover part.

7. The measurement system as claimed in claim 6, wherein the central part is made of plastic.

8. The measurement system as claimed in claim 6, wherein an inner side of the central part has a structured surface, ribs or a thread.

9. The measurement system as claimed in claim 6, wherein the channels are arranged in the cover part.

10. The measurement system as claimed in claim 6, wherein the cover part is made of aluminum.

11. The measurement system as claimed in claim 10, wherein a surface of the aluminum cover part is anodized.

12. The measurement system as claimed in claim 1, wherein at least three radiation detectors are provided.

13. The measurement system as claimed in claim 2, wherein each axis of all of the channels is arranged inclined at the angle with respect to the optical axis.

14. The measurement system as claimed in claim 5, wherein the infrared radiation source is a thermal radiation source.

15. The measurement system as claimed in claim 6, wherein the radiation source is arranged in the base part.

16. The measurement system as claimed in claim 6, wherein the radiation detectors are arranged in the cover part.
